(19) United States
(12) Patent Application Publication
(10) Pub. No.: US 2007/0047749 A1
(43) Pub. Date: Mar. 1, 2007

(54) Hearing aid with transponder device and corresponding data transmission method

(76) Inventors: Thomas Kasztelan, Singapore (SG); Wee Haw Koo, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/515,283

(22) Filed: Aug. 31, 2006

(30) Foreign Application Priority Data
Aug. 31, 2005 (DE) 10 2005 041 355.2

(51) Int. Cl. H04R 25/00

(52) U.S. Cl. 381/315

(57) ABSTRACT

The object is to automate and simplify the programming of a hearing aid or some other hearing apparatus. Toward that end provision is made to provide the hearing aid with a transponder device which is connected to a signal processing means and an antenna device of the hearing aid. By means of the transponder device it is possible to extract energy for the signal processing device, for example, from a data signal received by the antenna device. As a result it is possible to program, by wireless means, a hearing aid which is not equipped with a battery or which is not switched on.

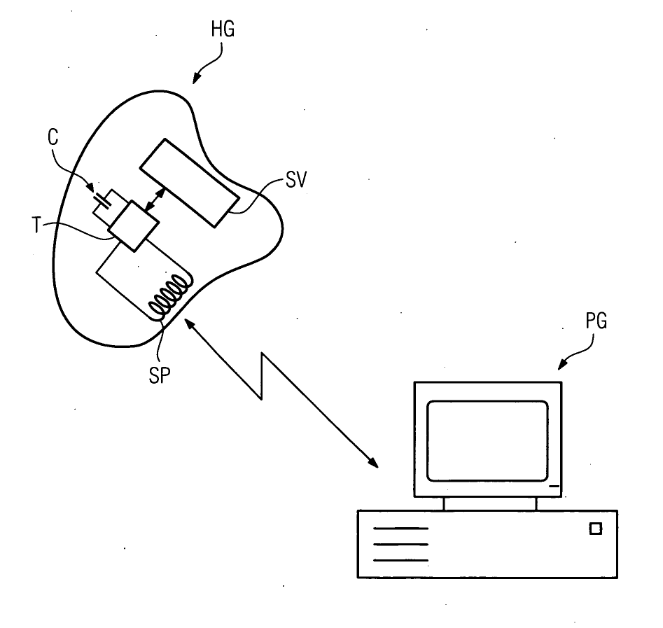

### CROSS REFERENCE TO RELATED APPLICATIONS

This application claims priority of German application No. 10 2005 041 355.2 filed Aug. 31, 2005, which is incorporated by reference herein in its entirety.

### FIELD OF THE INVENTION

The present invention relates to a hearing aid for wearing in or behind the ear, having an antenna device for the purpose of wirelessly transmitting data from and/or to an external device and a signal processing device for the purpose of storing and/or processing signals. The present invention further relates to a corresponding method for transmitting data to a hearing aid of said type.

### BACKGROUND OF THE INVENTION

Hearing aids are typically programmed in a hardwired manner based on data transmission from a programming device to the hearing aid that is to be programmed. This means that a suitable cable must be connected to the hearing aid for the purpose of programming. A disadvantage with this approach is that the operating step of cabling or plugging in is necessary. It is particularly unfavorable for small hearing aids such as ITE (in-the-ear) and CIC (completely-in-the-channel) hearing aids that a special programming socket must be provided on the hearing aid.

It also reveals itself as disadvantageous if, for the purpose of programming the device, a battery must first be inserted into the hearing aid in order to be able to perform the programming operation at all. This means that a programming operation often can only be performed when the hearing aid is being set up for an actual customer.

A method for configuring the functional properties of a hearing aid is also known from the patent specification DE 199 49 604 B4. According thereto, a separate data carrier is provided by the manufacturer in parallel with the device, said data carrier containing configuration upgrade software as well as, if necessary, accompanying software. At the factory the hearing aid is equipped as a basic version, i.e. the IC of the hearing aid is programmed in such a way that the hearing aid has only the minimum possible functionality. A dealer can then introduce the data carrier, in particular a chip card, into a corresponding reader and plug the IC into a programming station connected to the reader. In this way the dealer is able to reprogram a basic device to create a high-end hearing aid. Here too, the above-mentioned disadvantages still apply.

Wirelessly programmable hearing aids are known from numerous publications, including, for example, from DE 36 42 828H, DE 195 41 648 A1, WO 98 16086 A1 and WO 2001 54458 A2.

The publication DE 34 85 926 T2 discloses a cochlear implant system with physiological [sic] testing or programming by means of mapped patient responses. A voltage induced on the implant side is rectified by a silicon diode and filtered by a power supply filter capacitor, thereby producing a power coupling system.

### SUMMARY OF THE INVENTION

The object of the present invention is to propose a hearing aid which is improved in terms of its programming.

This object is achieved according to the invention by a hearing aid for wearing in the ear or behind the ear, having an antenna device to allow wireless transmission of data from and/or to an external device, a signal processing device for signal storage and/or signal processing and a battery compartment for inserting a battery by means of which the antenna device and/or the signal processing device can be provided with power, as well as a transponder device which is connected to the antenna device and the signal processing device. By means of the transponder device it is possible to obtain energy for powering the signal processing device and/or the antenna device from a data signal received by the antenna device.

Also provided according to the invention is a method for transmitting data to a hearing aid with battery compartment for wearing in the ear or behind the ear, characterized by provision of the hearing aid without battery or of the switched-off hearing aid, transmission of a data signal to the hearing aid, extraction of energy and of data from the data signal by the hearing aid.

Thanks to the wireless programming the hearing aid according to the invention no longer requires a programming socket. This dispenses with the need for an aperture for the programming socket and enables the hearing aid to be produced to a simpler and smaller design.

A further advantage of the hearing aid according to the invention is that the user or hearing aid wearer can move freely during the programming. Furthermore no energy from a device-internal battery is required for the data transmission to/from the hearing aid. As a result the battery life of a hearing aid, for example, can be considerably increased.

The data signal received by the antenna device preferably includes programming data. This enables the hearing aid to be programmed wirelessly before a battery has been inserted into the hearing aid. This is of great advantage, in particular during the manufacture and preprogramming of hearing aids.

The data signal can additionally be used for activating and controlling the hearing aid, enabling internal data to be transmitted by said hearing aid. This means that it is also possible to read out data from a hearing aid, for example, without the latter being ready for operation.

The antenna device of the hearing aid according to the invention can have a coil. By this means an inductive transmission of the data as well as a corresponding injection of energy into the hearing aid is possible in a very simple manner.

The hearing aid can be embodied as an ITE or CIC hearing aid. In these embodiments the inventive advantages make themselves particularly noticeable, since said hearing aids are very small and benefit in particular from the absence of a programming socket.

### BRIEF DESCRIPTION OF THE DRAWINGS

The present invention will now be explained in more detail with reference to the accompanying drawing which depicts the programming of a hearing aid according to the invention in diagrammatic form.

### DETAILED DESCRIPTION OF THE INVENTION

The exemplary embodiment described in more detail below represents a preferred embodiment of the present invention.

The in-the-ear hearing aid HG shown in the figure has a signal processing means SV. Said signal processing means SV is to be programmed by means of a programming device PG. The programming is performed in a wireless manner via an inductive communication link. For this purpose the hearing aid HG has an electric coil SP. For the sake of clarity we have dispensed with showing a corresponding coil of the programming device PG. A programming device coil of said type must be held correspondingly close to the hearing aid HG during programming.

The coil SP in the hearing aid is connected as a receiving device to a transponder chip T. The latter has the task of establishing bidirectional communication between the hearing aid HG and the programming device PG in accordance with a predefined communication protocol. It is also bidirectionally connected to the hearing-aid-internal signal processing means SV. This means that the transponder T represents the interface or, as the case may be, a relay station between the signal processing means SV of the hearing aid HG and the programming device PG. It favorably ensures communication between the two components in the radio frequency range.

Also connected to the transponder T is a capacitor C in which it is possible to store energy which the transponder T extracts from received signals.

The programming of the hearing aid HG by the programming device PG accordingly takes place in that the programming device PG sends a corresponding programming signal to the hearing aid. The programming signal is embodied in such a way that the transponder T is also able to extract energy as well as the programming data from the programming signal. The capacitor C stores this energy in the form of an electrical charge and uses it to supply not only itself, but temporarily also the signal processing means SV of the hearing aid HG with electrical energy. This energy enables the programming data, for example, to be read into a corresponding memory of the hearing aid HG and the hearing aid to be configured accordingly or the hearing aid to be placed in a defined initial state. Alternatively or in addition, it is also possible to program the hearing aid via the transponder even with the battery inserted. However, if the battery is not used for the programming, it may be absolutely imperative or at least of advantage to switch off the output stage of the hearing aid on account of the high energy requirement or, as the case may be, not to switch it on in the first place.

However, the hearing aid HG according to the invention also permits data to be read out from it with the aid of the programming device PG. Toward that end, the programming device PG sends a corresponding trigger signal to the hearing aid HG. Said trigger signal HG simultaneously supplies the energy to charge the capacitor C for the readout operation. With the aid of the received energy the signal processing means provides the data to be read out and the transponder T, likewise fed by the capacitor C, sends the data to the programming device PG. The data can, of course, also be read out from the hearing aid during battery-powered operation.

Providing a wireless programming interface for a hearing aid on the basis of transponder technology is relatively easy and economical to achieve, since a receive coil is frequently installed in a hearing aid in any case and consequently only a transponder with capacitor would need to be introduced in addition. Since, however, transponder chips are standard components, recourse can be made to standard transmission technologies at low prices.

Thus, the following setup method for hearing aids can be realized according to the invention: The hearing aid HG is programmed for a basic setting in the switched-off state, e.g. immediately following manufacture when the battery has not yet been inserted (optional). This programming endows the hearing aid HG with a basic functionality. The dealer, who sells different types of hearing aids, now activates specific functions dependent on type in the preprogrammed hearing aid HG or disables them or, as the case may be, loads additional functions. This reduces the programming overhead for the dealer to a minimum and the programming in the manufacturing facility, without cabling and without a battery being installed, can be automated and simplified to a considerably greater extent.

1-9. (canceled)

10. A hearing aid, comprising:
an antenna arranged within the hearing aid that wirelessly transmits a data signal between the hearing aid and an external device;
a signal processing device arranged within the hearing aid that process the data signal; and
a transponder device that is connected to the antenna and the signal processing device,
wherein the transponder device is configured to extract the data signal received by the antenna and to extract energy required for operating the signal processing device and the antenna from the data signal.

11. The hearing aid as claimed in claim 10, wherein the data signal includes programming data.

12. The hearing aid as claimed in claim 11, wherein the hearing aid is configured or set in an initial state according to the programming data in a battery switched off state or before inserting a battery.

13. The hearing aid as claimed in claim 10, wherein the data signal is a control signal that enables internal data of the hearing aid to be transmitted by the hearing aid.

14. The hearing aid as claimed in claim 13, wherein the internal data of the hearing aid is transmitted in a battery switched off state or before inserting a battery.

15. The hearing aid as claimed in claim 10, wherein the antenna comprises a coil.

16. The hearing aid as claimed in claim 10, wherein the transponder device is connected to a capacitor to store the extracted energy.

17. The hearing aid as claimed in claim 10, wherein the signal processing device stores the data signal.

18. The hearing aid as claimed in claim 10, wherein the hearing aid comprises a battery compartment for inserting a battery that supplies power for operating the antenna device or signal processing device.

19. The hearing aid as claimed in claim 10, wherein the hearing aid is an in-the-ear or completely-in-the-channel or behind the ear hearing aid.

20. A method for transmitting a data signal between the hearing aid and an external device without an energy supplied from a battery, comprising:
providing an antenna within the hearing aid for transmitting the data signal;
providing a signal processing device within the hearing aid for processing the data signal;
connecting a transponder device to the antenna and the signal processing device;
extracting the data signal received by the antenna via the transponder device;
extracting energy required for operating the antenna and the signal processing device from the data signal via the transponder device; and
transmitting the data signal with the extracted energy.

21. The method as claimed in claim 20, wherein the data signal includes programming data.

22. The method as claimed in claim 21, wherein the hearing aid is programmed for an initial basic setting according to the programming data with the extracted energy.

23. The method as claimed in claim 20, wherein the hearing aid is activated by the data signal to transmit internal data of the hearing aid.

24. The method as claimed in claim 20, wherein the hearing aid comprises a battery compartment for inserting a battery that supplies power for operating the antenna or signal processing device.

25. The method as claimed in claim 24, wherein the hearing aid is programmed and the data signal is transmitted between the hearing aid and the external device before inserting the battery or in a battery switched-off state.

26. The method as claimed in claim 20, wherein the data signal is transmitted wirelessly.
